(19) United States
(12) Patent Application Publication
(10) Pub. No.: US 2025/0030560 A1
(43) Pub. Date: Jan. 23, 2025

(54) Communication System and Industrial Automation Device for Processing a Web Request from a Client

(71) Applicant: Siemens Aktiengesellschaft, Muenchen (DE)

(72) Inventors: Hendrik GERLACH, Erlangen (DE); Jürgen REICHMANN, München (DE)

(21) Appl. No.: 18/772,673

(22) Filed: Jul. 15, 2024

(30) Foreign Application Priority Data
Jul. 17, 2023 (EP) 23185841

(51) Int. Cl. H04L 9/32; H04L 67/02; H04L 67/563

(52) U.S. Cl. CPC H04L 9/3263; H04L 67/02; H04L 67/563

(57) ABSTRACT

Industrial automation device for processing a web request from a client, and an automation system, for processing a web request from a client for retrieving a web service, wherein the communication system includes a web server for receiving the web request from the client and for transmitting a web response transformed on the basis of the web request back to the client, a proxy unit coupled to the web service, arranged separately from the web server and arranged downstream of the web server, where the web server includes a proxy adapter configured to couple the web server to the proxy unit arranged separately from and downstream of the web server, and the proxy adapter is furthermore configured to transform the web request into the web response in a manner dependent on the proxy unit arranged separately from and downstream of the web server and dependent on the web service.

### BACKGROUND OF THE INVENTION

### 1. Field of the Invention

The invention relates to a communication system and an industrial automation device for processing a web request from a client.

### 2. Description of the Related Art

Presently, attempts are being made to transform the concept of open application systems (“apps”) into the world of automation. One aspect on the way to transformation into the world of Industry 4.0 is web solutions that are used, e.g., for start-up, parameterization and diagnostics and that also provide interfaces for operator control/observation.

With the use of web technology, a challenge rapidly arises in open systems as soon as a plurality of subsystems of a device bring with them their own web servers or web solutions. These independent web servers need to be integrated so that they offer the end user just one web access point per device, as is familiar both from previous automation devices and from a specific network such as the Internet.

Existing web integration solutions, the so-called reverse proxies (proxy unit), manage to offer a single access point to the device (e.g., on the known web ports 80 or 443), but do not offer support for integration on the content page (i.e., the web pages themselves). In this regard, each subsystem developer follows their own ideas regarding content representation in the web environment. This causes such automation solutions outwardly to seem fragmented and not so much a uniform overall solution from “a unified whole”.

An expedient path from integration of diverse independent web solutions toward a solution with support for content harmonization is a “portal web server”. The portal web server is per se the uniform access point to the device for the user. System-conforming web solutions of individual components can be integrated in the portal web server and thus help to create a uniform solution for end customers. Integration in a conforming manner means that web pages of subcomponents also look like “system web pages” for system and platform management. The end customer is thus given the impression of a uniform system.

FIG. 1 shows a web platform from the prior art, comprising the following architectural features:
An industrial app store runtime “IAR” makes it possible to run apps from a central (official) industrial app store. For the operator of the app store, this runtime ensures that only apps for which corresponding rights have been acquired can be executed.
A local app runtime “LAR” makes it possible for the user additionally to operate apps having other properties. Such apps are e.g. the user's apps that the user does not wish to import in the central industrial app store.

While the IAR in the prior art implements a central management pattern (i.e., apps are pushed from central device management to the devices (or the IAR thereof)), an LAR in conjunction with a first platform can enable decentralized app management. In other words, apps are pulled on the device itself from an app store, as is customary nowadays for customer devices such as smartphones. In both cases, the management in the runtimes generally takes place by way of web servers and/or by way of web APIs of web services. Even in such a simple configuration, two independent management web servers already encounter one another:
a first web server unit (first management web server) for the LAR and
a second web server unit (second management web server) for the IAR.

In accordance with the prior art, these two management web servers are to be integrated via an upstream proxy unit.

In the proxy unit, each sub-web server behind that is assigned a sub-URL (URL prefix) at which this web server is reachable externally via the proxy unit. In the prior art, therefore, the central point of entry into the web server “application cluster” is always the proxy unit, which undertakes the distribution of the arriving requests among the sub-web servers. This “splitting” occurs based the URL prefixes that are assigned to the downstream web servers in a dedicated manner.

For this purpose, the proxy unit has a configuration file, in which (inter alia) the provided URLs for the downstream web servers and the IP addresses thereof are defined. Management requests from the IAR and also management requests from the LAR meet at this configuration point in an uncoordinated manner.

In summary, besides the visible problems in the area of the user interface and operator control philosophy, by comparison with a portal web server approach, the conventional proxy unit gives rise to a number of problems:

The first web server unit in the first management domain is used for the configuration of the system and thus very generally also for the configuration of the reverse proxy belonging to the system. In the case of an automatic or manual misconfiguration of the reverse proxy, the first web server unit of the device is no longer reachable. Therefore, this misconfiguration is also not correctable using this first web server unit.

The reverse proxy must be fully managed, i.e., for each new root web page in the portal web server and also in the app store runtime, the configuration must be tracked in the reverse proxy. Any manual configuration of communication paths is a potential source of error and weak point.

Many existing web applications are not designed for reverse proxies. Such web applications on different web servers cannot check in a simple manner whether they are being operated behind a reverse proxy. For example, cookies of a web application may overwrite one another in the browser. Example: If a web server of a programmable logic controller (PLC) is operated behind a reverse proxy, this results, inter alia, in login cookies overwriting one another. Consequently, whenever a user has changed the web server, the user has to log in anew again.

The IP address of the client is no longer visible in the IP packet that reaches the first web server unit located behind the reverse proxy (it always recognizes the IP address of the reverse proxy as source address), which considerably reduces in particular the value of the protocolling in the first web server unit. Such restricted visibility of the client requests that pass through the reverse proxy makes troubleshooting more difficult and adversely affects the security of the system.

The system-dictated termination of TLS tunnels at the reverse proxy results in a security degradation. A reverse proxy operates conceptually as a man-in-the-middle “attacker” because as an ISO layer 7 gateway it interrupts secure tunnels to the destination web server (e.g., the first web server unit). Compromising the reverse proxy thus allows attackers access to the unencrypted data traffic. Besides this breach of end-2-end security, there are further problems regarding certificate handling between reverse proxy and destination web server. The reverse proxy has to trust all web servers located behind it (i.e., their (different) certificates) in order that, after interrupting the tunnels on the entry side, it can at least again establish secure tunnels on the other side (to the endpoint web servers). Owing to the handling overhead, the connections between the reverse proxy and the destination web servers are usually even operated in an unsecured manner. These connections are thus directly attackable, which can pose a problem depending on the security policy.

### SUMMARY OF THE INVENTOIN

Against this background, it is an object of the present invention to provide a communication system and industrial automation device for improving the management of web services that are reachable via a web server.

This and other objects and advantages are achieved in accordance with a first aspect by a communication system, in particular an automation system, for processing a web request from a client for retrieving a web service in a specific network is proposed. The communication system comprises a web server for receiving the web request from the client and for transmitting a web response transformed on the basis of the web request back to the client, a proxy unit arranged separately from the web server and arranged downstream of the web server in the communication system, the said proxy unit being coupled to the web service.

The web server comprises a proxy adapter configured to couple the web server to the proxy unit arranged separately from and downstream of the web server, and the proxy adapter is furthermore configured to transform the web request into the web response in a manner dependent on the proxy unit arranged separately from and downstream of the web server and dependent on the web service.

In accordance with the communication system in accordance with the first aspect, the management of web services that are reachable via a web server is improved by virtue of the fact that the web server is no longer arranged behind the proxy unit, but rather is arranged in front of the proxy unit. In other words, the proxy unit is arranged downstream of the web server. This means that, as a result of this specific arrangement, the web server now changes from being a backend server to a frontend server and, as a result, takes on the primary role that was allocated to the proxy unit in accordance with the prior art. Consequently, the web server receives all web requests to a device of the communication system as a central web server, as a result of which the central web server becomes a portal web server.

In order to still enable access to the web solutions of the applications executing on the further local decentralized application runtime environment (IAR), the proxy unit is suitably linked to the (portal) web server via the proxy adapter. The proxy unit is now situated behind the web server and is now uniquely and exclusively assigned to the IAR.

This has the technical effect that the proxy unit is now no longer used for the web access to the first management domain and is also no longer managed from the first management domain. This has the advantage that a logical separation arises between the first management domain and the second management domain. The first management domain comprises the portal web server and the proxy adapter. The second management domain begins at the proxy unit. The conflicts of management of the proxy unit from a number of sides are thus eliminated.

Automatic or manual misconfigurations, even if they still occur after the abovementioned management conflict has been resolved, now concern only the second management domain. A functional web access that is no longer on the part of the second management domain can advantageously be reset again to a functional initial state by the first management domain. Moreover, in the case of an automatic or manual misconfiguration of the proxy unit, the first management domain and the web server are now at least still reachable and possibly only apps in the second management domain are no longer reachable. The first management domain and the web server can thus be operated independently of the proxy unit.

What is furthermore advantageous as a result of the upstream arrangement of the web server is that the IP address of the client is now again visible in the IP packet that reaches the web server. This facilitates troubleshooting and increases the security of the communication system.

The proxy unit is now arranged downstream of the web server. As a result, a system-dictated termination of TLS tunnels at the proxy unit is obviated, which likewise increases the security of the communication system.

In addition, the performance and the latency (transaction latency) of the communication system increase since the downstream proxy unit need no longer function as a layer 7 converter and does not have to terminate TCP and TLS connections on one side and re-establish them again on the other side.

The communication system can be implemented in particular within an automation apparatus or as an automation apparatus. The automation apparatus can be an apparatus from the process industry, the chemical industry, the pharmaceutical industry, the petrochemical industry, or an apparatus from the food and beverage industry. This also includes any apparatuses from the manufacturing and production industry and apparatuses in which, e.g., automobiles or goods of any kind are produced. Furthermore, the automation apparatus can also be configured as an energy generating apparatus, such as a wind turbine, a solar apparatus or a power plant and/or as an energy distribution apparatus.

A web request is a request made by a client, such as a web browser, to the web server to retrieve the web service. Web requests are particularly sent via the hypertext transfer protocol (HTTP), for which reason the web request may also be referred to as an HTTP request.

A web response passes back to the client again as a reaction to the transmitted web request from the web server which processes the transmitted web request and converts the web response. The web response is an HTTP response, in particular.

A client (also called client-side application, client application or client program) denotes a computer program that is executed on a terminal of a network and communicates with a server or web server. Preferably, the terminal itself that retrieves services from a server is a client.

A web service is any service that is situated in a specific network, such as a local network or the Internet, or is connected thereto, such as a web page, a web application, an application or a service, in particular a microservice. Web services are identified with the aid of uniform resource identifiers (URIs).

A specific network is in particular a local network or the Internet. The local network can be formed as an enterprise network or as a closed computer network.

A web server is in particular a server that transmits documents to clients, such as a web browser. The term web server denotes the computer with web server software or merely the web server software itself. Preferably, the web server is formed as a portal web server. A portal web server is a central server that receives all web requests to a device of the communication system and subsequently selects and forwards them to the correct location.

The term “arranged downstream” particularly means that the web server is arranged before the proxy unit and the latter is arranged after the web server. In other words, the web server, rather than the proxy unit, receives the web request first and can then forward the web request to the proxy unit via the proxy adapter.

Preferably, the term “arranged separately” means that the web server and the proxy unit are arranged in a manner logically separated from one another. A “logical separation” particularly means that the web server has a first allocated logical address, such as a TCP-IP address, in the communication system, whereas the proxy unit has a second allocated logical address in the communication system.

A proxy unit is a communication interface in the communication system. The proxy unit operates in particular as a mediator that receives web requests on one side in order then, via its own address, to establish a connection to another side. The proxy unit is configured in particular as a reverse proxy.

In particular, the proxy adapter receives the web request. The proxy adapter serves for linking or coupling the downstream proxy unit. Preferably, a web request not processed in the preceding components, i.e., the URL handler chain, is forwarded from the proxy adapter to the proxy unit of a second management domain.

The respective unit, for example, the proxy unit, can be implemented in the form of hardware and/or also in the form of software. In the case of an implementation in the form of hardware, the respective unit can be formed as a device or as part of a device, such as a computer or as a microprocessor. In the case of an implementation in the form of software, the respective unit can be formed as a computer program product, as a function, as a routine, as part of a program code or as an executable object.

In accordance with one embodiment, the web server is arranged in a first management domain and the proxy unit arranged separately from and downstream of the web server is arranged in a second management domain, where the first and second management domains are logically separated from one another.

The above explanation of the term “logical separation” analogously applies to this embodiment as well.

In particular, in the communication system in accordance with the first aspect, the first and second management domains can be arranged spatially separately from one another at different locations and/or devices.

In accordance with a further embodiment, the first management domain is formed as a local decentralized application runtime environment comprising a local or remote APP store having at least one local application, and the second management domain is formed as a further local decentralized application runtime environment comprising a central APP store having at least one centrally stored application.

The first management domain is in particular a “local app runtime”, or “LAR” for short. A local application is in particular an application which is not imported in the central APP store.

The second management domain is in particular an “industrial app store runtime”, or “IAR” for short.

In particular, the term “remote APP store” means that this APP store is not arranged in the first management domain, but is however connected to the first management domain in order to enable access to applications of this APP store.

In accordance with a further embodiment, the web server comprises a uniform resource locator handler chain having a plurality of uniform resource locator handlers, where the proxy adapter in the web server is arranged at the end of the uniform resource locator handler chain.

In accordance with a further embodiment, the plurality of uniform resource locator handlers of the uniform resource locator handler chain are arranged in series successively in the web server, where each uniform resource locator handler of the uniform resource locator handler chain is configured to forward the received web request to the next uniform resource locator handler in the series, and where the last uniform resource locator handler in the series is configured to transmit the forwarded received web request to the proxy adapter and to receive the transformed web response from the proxy adapter.

The arrangement of the proxy adapter at the end of the URL handler chain in accordance with the presently contemplated embodiment has the following advantages:

This particular arrangement of the proxy adapter has the effect that all web requests, in particular URL requests, not dealt with in the first management domain are received by the proxy adapter, whereas in the prior art, without this particular arrangement, an http error 404 message would be returned for each web request not dealt with.

Moreover, the URL handlers of the URL handler chain and thus the web pages of the first management domain are given higher priority than the proxy unit and thus also the web servers behind that in the IAR and the apps thereof. This is desirable in particular for the management web pages for the first management domain because the IAR is merely a downstream subsystem after the first management domain.

In addition, the arrangement of the proxy adapter as the last URL handler in the URL handler chain prevents the high latencies inevitably associated with the proxy unit from having an adverse effect on the URL handlers of the URL handler chain and thus on web pages of the first management domain.

In particular, the last uniform resource locator handler in the series is configured to transmit the forwarded received web request to the proxy adapter and to receive the transformed web response as part of a response chain from the proxy adapter.

Preferably, the plurality of uniform resource locator handlers of the handler chain comprise a first URL handler and a second URL handler, where the second URL handler may also be referred to as the next URL handler. In particular, the first and second URL handlers are realized by a backend web framework. One example of such a web framework is the Node.js based Express.js.

Moreover, the first URL handler can be responsible for static web pages, while the second URL handler can be responsible for dynamically generated web pages.

In accordance with a further embodiment, the proxy adapter for transforming the web request into the web response is configured to convert the web request into a network request, in particular into an HTTP request, to transmit the network request to the proxy unit arranged separately from and downstream of the web server, to receive a network response, in particular an HTTP response, from the proxy unit arranged separately from and downstream of the web server in a manner dependent on the web service and based on the network request, and to convert the received network response into the web response.

The term “transforming” describes in particular an information transformation because the data content of the medium to be transformed changes, here namely the data content of the web request changes into a data content of the web response.

The term “converting” preferably describes a format conversion because the format of the medium to be transmitted or to be converted changes. Here, for example, the web request in a computer format, such as source code or software code (programming code), is converted into a network request in the HTTP format. The median to be transmitted or to be converted changes here in particular from the computer format in the form of the web request to a network format, such as the HTTP format, in the form of the network request.

In accordance with a further embodiment, the proxy unit is configured, based on the received network request and in a manner dependent on a configuration file of the proxy unit for obtaining a forwarding result, to check whether a specific web service requested via the network request is present in the second management domain for the purpose of forwarding the network request to this specific web service, where the forwarding result is positive if the specific web service is present in the second management domain, where the forwarding result is negative if the specific web service is not present in the second management domain, where the network response is configured as a positive message if the forwarding result obtained is positive, and where the network response is designed as an error message, in particular an HTTP error message if the forwarding result obtained is negative.

In other words, the proxy unit checks with the aid of its configuration whether the converted network request can be forwarded to a specific web service assigned to it for processing purposes and—given a positive result of the checking (positive forwarding result)—the proxy unit implements this forwarding. Afterward, the proxy unit then receives a positive message from the specific web service or a web server connected to the specific web service. The proxy unit in turn forwards the positive message in the form of the network response to the proxy adapter. If the specific web service is not present, then (depending on the situation) either the proxy unit or a web server downstream thereof generates an error message, in particular the HTTP error message (negative forwarding result).

If the forwarding result is negative because the specific web service is not present in the second management domain, then it may either be the case that the specific web service requested via the network request is indeed known to the proxy unit, but the proxy unit is not connected thereto (for example, via a downstream web server of the second management domain) and the error message is therefore generated. In another case, in particular, the specific web service requested via the network request is not known to the proxy unit and the error message is therefore generated.

In particular, a response of a downstream web server (a positive message) arranged behind the proxy unit in the second management domain or else the error message returns to the proxy adapter again as a response to the network request generated by the proxy adapter. On this return path, the proxy adapter again converts the http response (network response) that arrives from the proxy unit into a web response for the components of the web server of the first management domain and feeds this web response into the response chain of the components of the web server. Finally, a base web server in the portal web server can deliver the corresponding web response to the requesting client, such as a web browser.

In accordance with a further embodiment, the communication system furthermore comprises a certificate store for storing digital certificates, where the stored digital certificates comprise a first digital certificate for the web server and a second digital certificate for the proxy unit, and where the certificate store is configured to store the first digital certificate in a manner dependent on the web server and to provide it for the web server and to store the second digital certificate in a manner dependent on the proxy unit and to provide it for the proxy unit.

A certificate store serves to keep digital certificates secure on a computer system. The first management domain and the second management domain use the shared certificate store. As a result, this advantageously facilitates the management of the digital certificates of both management domains.

In particular, the certificate store is connected to a certificate authority (CA). Preferably, the certificate authority is arranged externally to the communication system. A certificate authority (CA) is an entity that stores, signs and issues the digital certificates. A digital certificate certifies the ownership of a public key by the named subject of the certificate. A digital certificate is a digital data set, usually in accordance with International Telecommunication Union Telecommunication Standardization Sector (ITU-T) or Internet Engineering Task Force (IETF) standards, which confirms specific properties of persons or objects and the authenticity and integrity of which can be verified by cryptographic methods.

In accordance with a further embodiment, the web server and the proxy unit, in a manner dependent on the first digital certificate and the second digital certificate, are configured to set up an encrypted channel between the proxy adapter and the proxy unit for the secure transmission of the network request and the network response between the proxy adapter and the proxy unit, where the encrypted channel is secured in particular via HTTPS.

The encrypted channel between the proxy adapter and the proxy unit increases the security of the communication system since now end-to-end security secured via the encrypted channel is established between the first and second management domains. Moreover, end-to-end security is no longer breached because any communication between the proxy adapter and the proxy unit now occurs in a secured manner via HTTPS via the encrypted channel.

Overall, the first and second digital certificates are signed by a certificate authority that is trusted (trustworthy) jointly (i.e., by the first and second management domains). This ensures mutual trust between the proxy adapter of the portal web server of the first management domain and the proxy unit for the second management domain. The above encrypted channel between the two can also be realized on this basis. Preferably, an authentication of the proxy adapter vis-à-vis the proxy unit is not required because the proxy adapter appears here as a further client. The logon information of the client may be relevant to the access rights to a further web server in the second management domain. This information is forwarded in particular from the proxy adapter to the proxy unit.

The encrypted channel is established in particular as follows:

Firstly, the first certificate is signed by a superordinate certificate authority external to the communication system. The first certificate is formed here in particular as a CA certificate.

Afterward, the proxy unit retrieves the second certificate and the associated private key from the certificate store. The second certificate is configured here in particular as a server certificate. Moreover, the second certificate is preferably signed with the first certificate.

The proxy unit then authenticates itself vis-à-vis the proxy adapter or the web server with its signed second certificate. The proxy adapter verifies in particular the signed first certificate, via which the second certificate was signed, based on the certificates contained in the certificate store. The certificate store has all certificates, such as the CA certificate, which are trustworthy.

Both the proxy unit and the proxy adapter trust the same certificate authority and the signed first certificate is thus trustworthy. Consequently, the authentication is successful.

Preferably, the proxy unit and the proxy adapter then negotiate session keys between one another in order thereby then to establish the encrypted channel.

The objects and advantages are achieved in accordance with a second aspect by an industrial automation device, in particular a process control device, for processing a web request from a client for retrieving a web service in a specific network is proposed. The industrial automation device comprises a web server for receiving the web request from the client and for transmitting a web response transformed on the basis of the web request back to the client, a proxy unit arranged separately from the web server and arranged downstream of the web server on the industrial automation device, where the proxy unit is coupled to the web service. The web server comprises a proxy adapter configured to couple the web server to the proxy unit arranged separately from and downstream of the web server, and the proxy adapter is furthermore configured to transform the web request into the web response in a manner dependent on the proxy unit arranged separately from and downstream of the web server and dependent on the web service.

The process control device is in particular an IoT device or an edge device. The process control device comprise a programmable logic controller (PLC). In particular, the process control device can be established in the form of software or parts of the process control device can be formed as software. Moreover, at the same time, other parts of the process control device can also be realized in hardware.

In accordance with the second aspect, the first management domain and the second management domain are not arranged spatially separately from one another, but rather are implemented on a single device, i.e., the industrial automation device.

The technical effects and advantages described for the communication system in accordance with the first aspect equally apply to the industrial automation device in accordance with the second aspect.

Furthermore, the embodiments and features described with reference to the communication system in accordance with the first aspect equally also apply to the industrial automation device in accordance with the second aspect.

In accordance with one embodiment of the second aspect, the web server is arranged in a first management domain and the proxy unit arranged separately from and downstream of the web server is arranged in a second management domain, where the first management domain and the second management domain are logically separated from one another.

In accordance with a further embodiment of the second aspect, the first management domain is formed as a local decentralized application runtime environment comprising a local or remote APP store having at least one local application, and the second management domain is formed as a further local decentralized application runtime environment comprising a central APP store having at least one centrally stored application.

In accordance with a further embodiment of the second aspect, the local decentralized application runtime environment is configured to implement pulling of the local application to the industrial automation device in a manner dependent on the received web request, where the further local decentralized application runtime environment is configured, in a manner dependent on a network request received via the proxy unit, to load the web service and to provide it to the proxy unit for provision to the client.

The term “pulling of a local application” may also be referred to as a “process of pulling” a local application. The process in which the further local decentralized application runtime environment is configured to load the web service and to provide it to the proxy unit for provision to the client in a manner dependent on a network request received via the proxy unit may also be referred to as “pushing” or a “process of pushing” the web service or a centrally stored application to the proxy unit.

In accordance with a further embodiment of the second aspect, the proxy adapter for transforming the web request into the web response is configured to convert the web request into a network request, in particular into an HTTP request, to transmit the network request to the proxy unit arranged separately from and downstream of the web server, to receive a network response, in particular an HTTP response, from the proxy unit arranged separately from and downstream of the web server in a manner dependent on the web service and based on the network request, and to convert the received network response into the web response.

In accordance with a further embodiment of the second aspect, the local application and the centrally stored application are configured to implement open-loop and closed-loop control processes in a manner dependent on the industrial automation device in a communication system.

In accordance with a further embodiment of the second aspect, the local application and the centrally stored application are configured to acquire, compress and/or process sensor data of sensors from the communication system.

In accordance with a further embodiment of the second aspect, the local application and the centrally stored application are configured to output control data at least from the industrial automation device.

In accordance with a further embodiment of the second aspect, the industrial automation device is configured to observe and/or to control processes and/or apparatuses of the communication system in a manner dependent on the web service.

In accordance with a further embodiment of the second aspect, the web server is furthermore configured to observe and/or to control further processes and/or further apparatuses of the communication system in a manner dependent on the web service and in a manner dependent on the at least one local application.

In accordance with a further embodiment of the second aspect, the web server is furthermore configured to implement management processes in the first management domain and/or in the second management domain.

Further possible implementations of the invention also encompass not explicitly mentioned combinations of features or embodiments that have been described above or are described hereinafter in relation to the exemplary embodiments. In this case, a person skilled in the art will also add individual aspects as improvements or supplementations to the respective basic form of the invention. Irrespective of the grammatical gender of a specific term, persons with male, female, or other gender identity are also included.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further advantageous configurations and aspects of the invention are the subject of the dependent claims and the exemplary embodiments of the invention that are described hereinafter. The invention is explained in more detail below on the basis of preferred embodiments with reference to the attached figures, in which: .

FIG. 1 shows a schematic block diagram of a web platform in accordance with the prior art;

FIG. 2 shows a schematic block diagram of a communication system in accordance with one embodiment;

FIG. 3 shows a schematic block diagram of a web server in accordance with one embodiment; and

FIG. 4 shows a schematic block diagram of an industrial automation device in accordance with one embodiment.

### DETAILED DESCRIPTION OF THE EXEMPLARY EMBODIMENTS

In the figures, identical or functionally identical elements have been provided with the same reference signs, unless indicated otherwise.

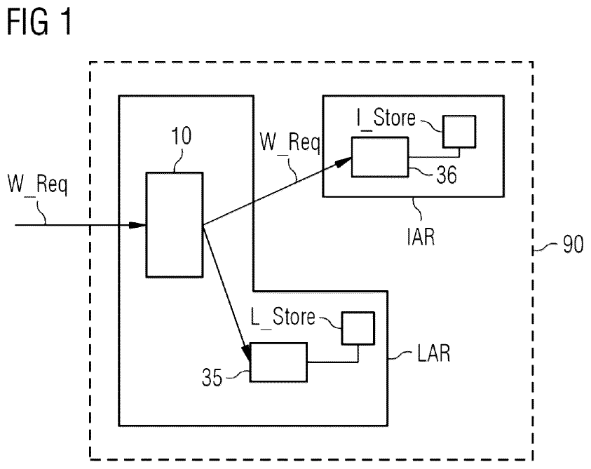

FIG. 1 shows a schematic block diagram of a web platform 90 in accordance with the prior art. As already described in the introduction, the web platform 90 in FIG. 1 comprises a first management domain LAR formed as a local decentralized application runtime environment having here a local APP store L_Store, and also a second management domain IAR formed as a further local decentralized application runtime environment having a central APP store I_Store.

As illustrated in FIG. 1, a proxy unit 10 is assigned to the first management domain LAR. In the case of the first management domain LAR, the management of the local or remote APP store L_Store and the applications thereof occurs via a first web server unit 35. In the case of the second management domain IAR, by contrast, the management of the central APP store I_Store and the applications thereof takes place by way of a second web server unit 36.

In FIG. 1, the two web server units 35, 36 are integrated via the upstream proxy unit 10. Here, in the proxy unit 10, each sub-web server behind that, i.e., the first and second web server units 35, 36, is assigned a sub-URL at which this respective web server is reachable externally via the proxy unit 10. Therefore, the central point of entry into the web platform 90 in FIG. 1 in the prior art is the proxy unit 10. Here, the proxy unit 10 undertakes the distribution of the arriving web requests, for example, the web request W_Req, among the respective sub-web servers such as the first web server unit 35 or the second web server unit 36. In FIG. 1, the web request W_Req is intended for the second management domain IAR, i.e., this web request is forwarded to the second web server unit 36.

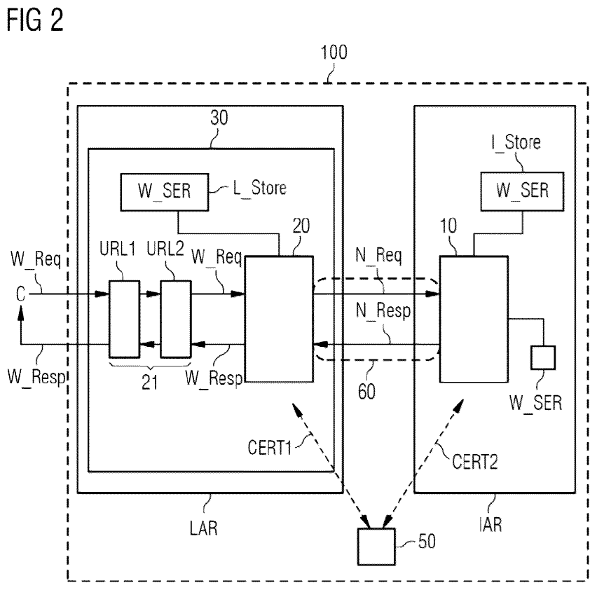

FIG. 2 shows a schematic block diagram of a communication system 100 in accordance with one embodiment. The communication system 100 in FIG. 2 is formed as an automation system established for processing a web request W_Req from a client C for retrieving a web service W_SER in a specific network. The communication system 100 in FIG. 2 comprises a web server 30 and a proxy unit 10.

In FIG. 2, the web server 30 is arranged in a first management domain LAR, where the first management domain LAR is formed as a local decentralized application runtime environment comprising a local or remote APP store L_Store having at least one local application. The proxy unit 10 arranged separately from and downstream of the web server 30 is arranged in a second management domain IAR, where the second management domain IAR is formed as a further local decentralized application runtime environment comprising a central APP store I_Store having at least one centrally stored application. Moreover, the first management domain LAR and the second management domain IAR are logically separated from one another. Moreover, the management of the central APP store I_Store and the applications thereof occurs via a web server unit (not illustrated in FIG. 2), such as the second web server unit 36 (cf. FIG. 1), arranged between the proxy unit 10 and the central APP store I_Store (not shown).

Furthermore, the web server 30 is configured for receiving the web request W_Req from the client C and for transmitting a web response W_Resp transformed based on the web request W_Req back to the client C. The proxy unit 10 is arranged separately from the web server 30 and arranged downstream of the web server 30 in the communication system 100 and is coupled to the web service W_SER. Consequently, in FIG. 2, the web server 30 is arranged upstream of the proxy unit 10.

Additionally, the web server 30 comprises a proxy adapter 20 configured to couple the web server 30 to the proxy unit 10 arranged separately from and downstream of the web server 30. Here, the proxy adapter 20 is furthermore configured to transform the web request W_Req into the web response W_Resp in a manner dependent on the proxy unit 10 arranged separately from and downstream of the web server 30 and dependent on the web service W_SER.

Here, moreover, the proxy adapter 20 for transforming the web request W_Req into the web response W_Resp is configured to convert the web request W_Req into a network request N_Req, here an HTTP request, to transmit the network request N_Req to the proxy unit 10 arranged separately from and downstream of the web server 30, to receive a network response N_Resp, here an HTTP response, from the proxy unit 10 arranged separately from and downstream of the web server 30 in a manner dependent on the web service W_SER and based on the network request N_Req, and to convert the received network response N_Resp into the web response W_Resp.

As likewise illustrated in FIG. 2, the web server 30 comprises a uniform resource locator handler chain 21 having a plurality of uniform resource locator handlers URL1, URL2, where the proxy adapter 20 in the web server 30 is arranged at the end of the uniform resource locator handler chain 21.

Here, the plurality of uniform resource locator handlers URL1, URL2 are arranged in series successively in the web server 30, where each uniform resource locator handler URL1, URL2 is configured to forward the received web request W_Req to the next uniform resource locator handler in the series. Here, the last uniform resource locator handler in the series is configured to transmit the forwarded received web request W_Req to the proxy adapter 20 and to receive the transformed web response W_Resp from the proxy adapter 20.

Furthermore, the communication system 100 in FIG. 2 comprises a certificate store 50 for storing digital certificates. The certificate store 50 is connected to a certificate authority (not shown). These stored digital certificates comprise a first digital certificate CERT1 for the web server 30 and a second digital certificate CERT2 for the proxy unit 10.

Here, the certificate store 50 is configured to store the first digital certificate CERT1 in a manner dependent on the web server 30 and to provide it for the web server 30 and to store the second digital certificate CERT2 in a manner dependent on the proxy unit 10 and to provide it for the proxy unit 10.

Furthermore, the web server 30 and the proxy unit 10, in a manner dependent on the first digital certificate CERT1 and the second digital certificate CERT2, are configured to set up an encrypted channel 60 between the proxy adapter 20 and the proxy unit 10 for the secure transmission of the network request N_Req and the network response N_Resp between the proxy adapter 20 and the proxy unit 10, where the encrypted channel 60 is secured in particular via HTTPS.

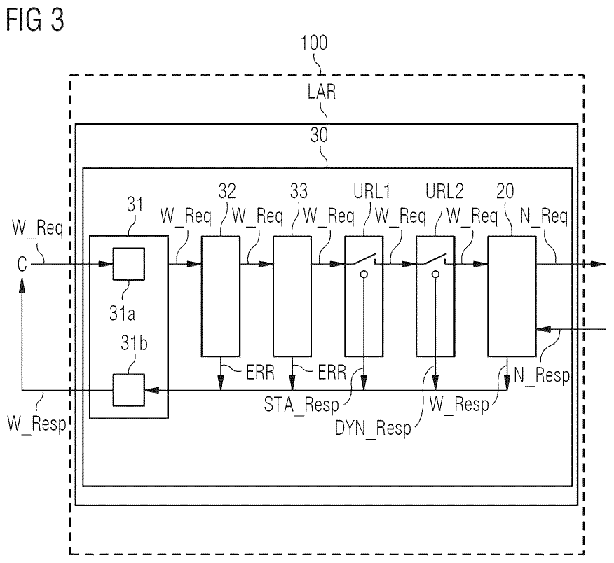

FIG. 3 shows a schematic block diagram of a web server 30 in accordance with one embodiment with the proxy adapter 20. Furthermore, the web server 30 in FIG. 3 comprises a base web server 31, an application firewall 32, an authentication component 33 and also a first URL handler URL1 and a second URL handler URL2, which form the URL handler chain 21 (cf. FIG. 2). The first URL handler URL1 is responsible for static web pages, while the second URL handler URL2 is responsible for dynamic web pages.

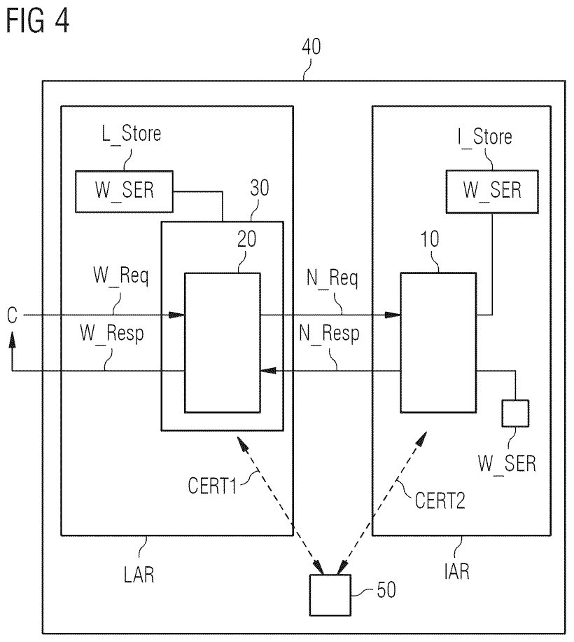

FIG. 3 shows the path of a web request W_Req through the web server 30 in FIG. 3. The base web server 31 is responsible for accepting the web request W_Req or web requests and sending the web responses W_Resp. The base web server 31 is supplemented by a series of URL handlers URL1, URL2, which are registered in the web server 30 for the handling of specific web requests. One type of web request handler, such as the first URL handler URL1, registers itself e.g. for dedicated URLs, such as for URLs on static web pages. Arriving web requests W_Req are forwarded from the base web server 31 to the respective responsible registered URL handlers. The responsible URL handler(s) then process(es) the web request W_Req and generate(s) the corresponding responses. These responses (e.g., web services W_SER (cf. FIGS. 2 and 4) such as web pages) are returned to a response sender 31b of the base web server 31 and are sent to the client C by the response sender 31b.

This is explained in detail subsequently:

A client C sends a web request W_Req, which is received by a request receiver 31a of the base web server 31 after passing through a network firewall (not shown).

Afterward, the web request W_Req is forwarded to an application firewall 32, which is optional but present in FIG. 3. An application firewall 32, in particular a web application firewall, serves to protect web applications from attacks via the HTTP protocol. If the application firewall 32 rejects the web request W_Req, then an error message ERR is sent back to the client C.

If the web request W_Req was not rejected by the application firewall 32, then the web request W_Req passes to an authentication component 33, which is optional but present in FIG. 3 and in which the client C is authenticated. If the client C is not accepted, then once again an error message ERR (often in the form of an HTML page) is sent back to the client C.

If this authentication of the client C was successful, then the web request W_Req is processed by a URL handler e.g. for static HTML pages, i.e., here the first URL handler URL1. If the web request W_Req is fulfilled by a static HTML page, then a static response STA_Resp in the form of the static HTML page passes back to the client C.

If the web request W_Req has not yet been processed positively in the first URL handler URL1, then the web request W_Req is forwarded to the next URL handler and processed there. In FIG. 3, this is the second URL handler URL2, which produces dynamically generated contents and processes dynamic web pages.

If the web request W_Req can be fulfilled in the second URL handler URL2, then a dynamic response DYN_Resp, such as in the form of a generated HTML page or a data description in the json format, passes back to the client C. If the web request W_Req cannot be fulfilled in the second URL handler URL2, then in the prior art a message (not shown) in the form of the http error 404 (“not found”) would pass back to the client C.

However, the web server 30 now comprises the proxy adapter 20. This means that if the web request W_Req cannot be fulfilled in the second URL handler URL2, then rather than a message in the form of the http error 404 (“not found”) being passed back to the client C as in the prior art, the web request W_Req is simply forwarded to the proxy adapter 20. The proxy adapter 20 in turn converts the web request W_Req into a network request N_Req and forwards the network request N_Req to the proxy unit 10 (cf. FIGS. 2 and 4) of the second management domain IAR (cf. FIGS. 2 and 4). Afterward, the proxy unit 10 checks with the aid of its configuration file whether the network request N_Req can be forwarded to a web service W_SER assigned to it (cf. FIGS. 2 and 4), such as a web server or a web app, for processing purposes in order to obtain a forwarding result. In the event of a positive forwarding result (positive message), the web service W_SER is present and the forwarding by the proxy unit 10 can take place. If the forwarding result obtained is negative, the network response N_Resp is configured as an error message ERR, here an HTTP error message.

FIG. 4 shows a schematic block diagram of an industrial automation device 40 in accordance with one embodiment. In FIG. 4, the industrial automation device 40 is configured as a process control device, in particular as a programmable logic controller. The industrial automation device 40 is configured for processing a web request (W_Req) from a client C for retrieving a web service W_SER in a specific network.

The industrial automation device 40 in FIG. 4 comprises a web server 30 and a proxy unit 10. In FIG. 4, the web server 30 is arranged in a first management domain LAR, where the first management domain LAR is formed as a local decentralized application runtime environment comprising a local or remote APP store L_Store having at least one local application. The proxy unit 10 arranged separately from and downstream of the web server 30 is arranged in a second management domain IAR, where the second management domain IAR is configured as a further local decentralized application runtime environment comprising a central APP store I_Store having at least one centrally stored application. Moreover, the first management domain LAR and the second management domain IAR are logically separated from one another.

Furthermore, the web server 30 is configured for receiving the web request W_Req from the client C and for transmitting back to the client C a web response W_Resp transformed based on the web request W_Req. The proxy unit 10 is arranged separately from the web server 30 and arranged downstream of the web server 30 in the communication system 100 and is coupled to the web service W_SER. Consequently, in FIG. 4, the web server 30 is arranged upstream of the proxy unit 10.

Additionally, the web server 30 comprises a proxy adapter 20 configured to couple the web server 30 to the proxy unit 10 arranged separately from and downstream of the web server 30. Here, the proxy adapter 20 is furthermore configured to transform the web request W_Req into the web response W_Resp in a manner dependent on the proxy unit 10 arranged separately from and downstream of the web server 30 and dependent on the web service W_SER.

Here, moreover, the proxy adapter 20 for transforming the web request W_Req into the web response W_Resp is configured to convert the web request W_Req into a network request N_Req, here an HTTP request, to transmit the network request N_Req to the proxy unit 10 arranged separately from and downstream of the web server 30, to receive a network response N_Resp, here an HTTP response, from the proxy unit 10 arranged separately from and downstream of the web server 30 in a manner dependent on the web service W_SER and based on the network request N_Req, and to convert the received network response N_Resp into the web response W_Resp.

Furthermore, in FIG. 4, the local decentralized application runtime environment is configured to implement pulling of the local application to the industrial automation device 40 in a manner dependent on the received web request W_Req.

The further local decentralized application runtime environment in FIG. 4 is configured, in a manner dependent on a network request N_Req received via the proxy unit 10, to load the web service W_SER and to provide it to the proxy unit 10 for provision to the client C.

Additionally, the local application and the centrally stored application are configured to implement open-loop and closed-loop control processes in a manner dependent on the industrial automation device 40 in a communication system 100 (cf. FIG. 2), to acquire, compress and/or process sensor data of sensors from the communication system 100, and to output control data at least from the industrial automation device 40.

Furthermore, the industrial automation device 40 is configured to observe and/or to control processes and/or apparatuses of the communication system 100 in a manner dependent on the web service W_SER.

In addition, the web server 30 is furthermore configured to observe and/or to control further processes and/or further apparatuses of the communication system 100 in a manner dependent on the web service W_SER and in a manner dependent on the at least one local application and to implement management processes in the first management domain LAR and/or in the second management domain IAR.

Although the present invention has been described on the basis of exemplary embodiments, it is modifiable in diverse ways.

Irrespective of the grammatical gender of a specific term, persons with male, female, or other gender identity are also included.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A communication system for processing a web request from a client for retrieving a web service in a specific network, the communication system comprising:
a web server for receiving the web request from the client and for transmitting a web response transformed based on the web request back to the client; and
a proxy unit arranged separately from the web server and arranged downstream of the web server in the communication system, said proxy unit being operatively coupled to the web service;
wherein the web server comprises a proxy adapter configured to couple the web server to the proxy unit arranged separately from and downstream of the web server;
wherein the proxy adapter is furthermore configured to transform the web request into the web response in a manner dependent on the proxy unit arranged separately from and downstream of the web server and dependent on the web service.

2. The communication system as claimed in claim 1, wherein the web server is arranged in a first management domain and the proxy unit arranged separately from and downstream of the web server is arranged in a second management domain; and wherein the first and second management domains are logically separated from one another.

3. The communication system as claimed in claim 2, wherein the first management domain is formed as a local decentralized application runtime environment comprising a local or remote APP store having at least one local application, and the second management domain is formed as a further local decentralized application runtime environment comprising a central APP store having at least one centrally stored application.

4. The communication system as claimed in claim 1, wherein the web server comprises a uniform resource locator handler chain having a plurality of uniform resource locator handlers; and wherein the proxy adapter (20) in the web server is arranged at an end of the uniform resource locator handler chain.

5. The communication system as claimed in claim 2, wherein the web server comprises a uniform resource locator handler chain having a plurality of uniform resource locator handlers; and wherein the proxy adapter in the web server is arranged at an end of the uniform resource locator handler chain.

6. The communication system as claimed in claim 3, wherein the web server comprises a uniform resource locator handler chain having a plurality of uniform resource locator handlers; wherein the proxy adapter in the web server is arranged at an end of the uniform resource locator handler chain.

7. The communication system as claimed in claim 4, wherein the plurality of uniform resource locator handlers of the uniform resource locator handler chain are arranged in series successively in the web server;
wherein each uniform resource locator handler of the uniform resource locator handler chain is configured to forward the received web request to a next uniform resource locator handler in the series; and
wherein the last uniform resource locator handler in the series is configured to transmit the forwarded received web request to the proxy adapter and to receive the transformed web response from the proxy adapter.

8. The communication system as claimed in claim 1, wherein the proxy adapter for transforming the web request into the web response is configured to convert the web request into a network request to transmit the network request to the proxy unit arranged separately from and downstream of the web server, to receive a network response from the proxy unit arranged separately from and downstream of the web server in a manner dependent on the web service and based on the network request, and to convert the received network response into the web response.

9. The communication system as claimed in claim 8, wherein the a network request comprises an Hypertext Transfer Protocol Secure (HTTPS) request and the network response comprises an HTTP response.

10. The communication system as claimed in claim 1, wherein the communication system furthermore comprises a certificate store for storing digital certificates;
wherein the stored digital certificates comprise a first digital certificate for the web server and a second digital certificate for the proxy unit; and
wherein the certificate store is configured to store the first digital certificate in a manner dependent on the web server and to provide it for the web server and to store the second digital certificate in a manner dependent on the proxy unit and to provide it for the proxy unit.

11. The communication system as claimed in claim 10, wherein the web server and the proxy unit, in a manner dependent on the first digital certificate and the second digital certificate, are configured to set up an encrypted channel between the proxy adapter and the proxy unit for secure transmission of the network request and the network response between the proxy adapter and the proxy unit; and
wherein the encrypted channel is secured via Hypertext Transfer Protocol Secure (HTTPS).

12. The communication system as claimed in claim 1, wherein the communication system comprises an automation system.

13. An industrial automation device for processing a web request from a client for retrieving a web service in a specific network, the industrial automation device comprising:
a web server for receiving the web request from the client and for transmitting a web response transformed based on the web request back to the client; and
a proxy unit arranged separately from the web server and arranged downstream of the web server on the industrial automation device, said proxy unit being operatively coupled to the web service;
wherein the web server comprises a proxy adapter configured to couple the web server to the proxy unit arranged separately from and downstream of the web server; and
wherein the proxy adapter is furthermore configured to transform the web request into the web response in a manner dependent on the proxy unit arranged separately from and downstream of the web server and dependent on the web service.

14. The automation device as claimed in claim 13, wherein the web server is arranged in a first management domain and the proxy unit arranged separately from and downstream of the web server is arranged in a second management domain; and wherein the first and second management domains are logically separated from one another.

15. The automation device as claimed in claim 14, wherein the first management domain is formed as a local decentralized application runtime environment comprising a local or remote APP store having at least one local application, and the second management domain is formed as a further local decentralized application runtime environment comprising a central APP store having at least one centrally stored application.

16. The automation device as claimed in claim 15, wherein the local decentralized application runtime environment is configured to performed pulling of the local application to the industrial automation device in a manner dependent on the received web request; and
wherein the further local decentralized application runtime environment is configured, in a manner dependent on a network request received via the proxy unit, to load the web service and to provide said web service to the proxy unit for provision to the client.

17. The automation device as claimed in claim 13, wherein the proxy adapter for transforming the web request into the web response is configured to convert the web request into a network request, to transmit the network request to the proxy unit arranged separately from and downstream of the web server, to receive a network response from the proxy unit arranged separately from and downstream of the web server in a manner dependent on the web service and based on the network request, and to convert the received network response into the web response.

18. The automation device as claimed in claim 14, wherein the proxy adapter for transforming the web request into the web response is configured to convert the web request into a network request, to transmit the network request to the proxy unit arranged separately from and downstream of the web server, to receive a network response from the proxy unit arranged separately from and downstream of the web server in a manner dependent on the web service and based on the network request, and to convert the received network response into the web response.

19. The automation device as claimed in claim 15, wherein the proxy adapter for transforming the web request into the web response is configured to convert the web request into a network request, to transmit the network request to the proxy unit arranged separately from and downstream of the web server, to receive a network response from the proxy unit arranged separately from and downstream of the web server in a manner dependent on the web service and based on the network request, and to convert the received network response into the web response.

20. The automation device as claimed in claim 16, wherein the proxy adapter for transforming the web request into the web response is configured to convert the web request into a network request, to transmit the network request to the proxy unit arranged separately from and downstream of the web server, to receive a network response from the proxy unit arranged separately from and downstream of the web server in a manner dependent on the web service and based on the network request, and to convert the received network response into the web response.

21. The automation device as claimed in claim 13, wherein the network request comprises an Hypertext Transfer Protocol Secure (HTTPS) request and the network response comprises an HTTP response.

22. The automation device as claimed in claim 13, wherein the local application and the centrally stored application are configured to implement open-loop and closed-loop control processes in a manner dependent on the industrial automation device in a communication system.

23. The automation device as claimed in claim 13, wherein the local application and the centrally stored application are configured to at least one of acquire, compress and process sensor data of sensors from the communication system.

24. The automation device as claimed in claim 13, wherein the local application and the centrally stored application are configured to output control data at least from the industrial automation device.

25. The automation device as claimed in claim 13, wherein the industrial automation device is configured to at least one of observe and control at least one of processes and apparatuses of the communication system in a manner dependent on the web service.

26. The automation device as claimed in claim 13, wherein the web server is furthermore configured to at least one of observe and control at least one of further processes and further apparatuses of the communication system in a manner dependent on the web service and in a manner dependent on the at least one local application.

27. The automation device as claimed in claim 13, wherein the web server is furthermore configured to implement management processes in at least one of the first management domain and the second management domain.

28. The industrial automation device of claim 13, wherein the industrial automation device comprises a process control device.
